(19) United States
(12) Patent Application Publication
(10) Pub. No.: US 2012/0107603 A1
(43) Pub. Date: May 3, 2012

(54) ARTICLE FORMED USING NANOSTRUCTURED FERRITIC ALLOY

(75) Inventors: Richard DiDomizio, Scotia, NY (US); Francis Johnson, Clifton Park, NY (US); Matthew Joseph Alinger, Albany, NY (US)

(73) Assignee: GENERAL ELECTRIC COMPANY, SCHENECTADY, NY (US)

(21) Appl. No.: 12/915,742

(22) Filed: Oct. 29, 2010

(51) Int. Cl. H01F 1/04; H01F 1/047; B32B 5/16

(52) U.S. Cl. 428/328; 252/62.55

(57) ABSTRACT

In one embodiment, an article is provided. The article comprises a soft magnetic component. The soft magnetic component includes a nanostructured ferritic alloy. The nanostructured ferritic alloy includes a plurality of nanofeatures disposed in an iron-containing alloy matrix, wherein the nanofeatures comprise an oxide.

### BACKGROUND

The invention relates generally to an article comprising a soft magnetic component. More particularly the invention relates generally to an article comprising a soft magnetic component comprising a nanostructured ferritic alloy.

Soft magnetic components play a key role in a number of applications, especially in electric and electromagnetic devices. There is a growing need for lightweight and compact electric machines. Compact machine designs may be realized through an increase in the rotational speed of the machine. In order to operate at high speeds, these machines need materials capable of operating at high flux densities. The components must also exhibit high tensile strength, without structural failure, according to service life requirements. The components at the same time should be capable of permitting relatively low magnetic core losses. One skilled in the art will appreciate that achieving high mechanical strength and superior soft magnetic performance concurrently may be difficult while using conventional materials to form the soft magnetic components. Generally a high strength component is obtained at the expense of important magnetic properties, such as magnetic saturation and core loss.

Accordingly, it is desirable to have an improved article comprising a soft magnetic component that is capable of maintaining its mechanical integrity and magnetic properties over a range of conditions ranging from higher stress and lower temperature to higher temperature and lower stress.

### BRIEF DESCRIPTION

In one embodiment, an article is provided. The article comprises a soft magnetic component. The soft magnetic component comprises a nanostructured ferritic alloy. The nanostructured ferritic alloy comprises a plurality of nanofeatures disposed in an iron-containing alloy matrix, wherein the nanofeatures comprise an oxide.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an electromagnetic device.

### DETAILED DESCRIPTION

For many electrical devices and components in a variety of applications, including aerospace, wind power, and electric vehicles, magnetic materials with relatively high permeability, high saturation magnetization, low core loss, and high mechanical strength may be required. There is a continuing need for soft magnetic components with improved magnetic properties and high mechanical strength. Embodiments of the invention described herein address the noted shortcomings of the state of the art. Disclosed herein is an article comprising a soft magnetic component. The soft magnetic component comprises a nanostructured ferritic alloy. The nanostructured ferritic alloy comprises a plurality of nanofeatures disposed in an iron-containing alloy matrix, wherein the nanofeatures comprise an oxide. The article may be employed in devices such as electric motors and generators that utilize a magnetic material in a rotating component in which both mechanical integrity and the magnetic properties may affect overall performance, longevity, and other factors. The use of nanostructured ferritic alloy in forming the soft magnetic component provides a rotating component that has a relatively higher strength, a relatively lower coercive loss, and a relatively higher saturation magnetization when compared to materials known in the art.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” and “the,” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components unless otherwise stated.

All ranges disclosed herein are inclusive of the endpoints, and the endpoints are combinable with each other. The terms “first,” “second,” and the like as used herein do not denote any order, quantity, or importance, but rather are used to distinguish one element from another.

Approximating language, as used herein throughout the specification and claims, may be applied to modify any quantitative representation that could permissibly vary without resulting in a change in the basic function to which it may be about related. Accordingly, a value modified by a term such as “about” is not limited to the precise value specified. In some instances, the approximating language may correspond to the precision of an instrument for measuring the value.

In one embodiment, an article is provided. The article comprises a soft magnetic component. The soft magnetic component comprises a nanostructured ferritic alloy. Nanostructured ferritic alloys are an emerging class of alloys. Typically the nanostructured ferritic alloy comprises an iron-containing alloy matrix that is strengthened by nanofeatures disposed within the matrix. As used herein, the term “nanofeatures” means particles of matter that have a longest dimension less than about 100 nanometers in size. Nanofeatures may have any shape, including, for example, spherical, cuboidal, lenticular, and other shapes. The magnetic and mechanical properties of the nanostructured ferritic alloys may be controlled by controlling, for example, the density (meaning the number density—number of particles per unit volume) of the nanofeatures in the matrix, the composition of the nanofeatures, and the processing used to form the article.

The nanofeatures of the nanostructured ferritic alloy comprise an oxide. In one embodiment, the oxide comprises titanium, and at least one additional element selected from yttrium, hafnium, aluminum, or zirconium, and in particular embodiments, the additional element is yttrium. In certain embodiments, the oxide also comprises one or more other elements, such as chromium, nickel, iron, molybdenum, tungsten, niobium, aluminum, tantalum, cobalt, or vanadium. The actual composition of the oxide will depend in part on the composition of the alloy matrix as well as the composition of the raw materials used in processing the material, which will be discussed in more detail below. In particular embodiments, the oxide comprises titanium and yttrium.

In one embodiment, the nanofeatures have a number density of at least about 10¹⁸ nanofeatures per cubic meter of the nanostructured ferritic alloy. In another embodiment, the nanofeatures have a number density of at least about 10²⁰ per cubic meter of the nanostructured ferritic alloy. In yet another embodiment, the nanofeatures have a number density of at least about 10²² per cubic meter of the nano structured ferritic alloy.

In one embodiment, the nanofeatures have an average size in a range from about 1 nanometer to about 100 nanometers. In another embodiment, the nanofeatures have an average size in a range from about 1 nanometer to about 50 nanometers. In yet another embodiment, the nanofeatures have an average size in a range from about 1 nanometer to about 25 nanometers. Having such very fine nanofeatures is advantageous in that the nanofeatures may act to impede dislocation motion, thereby strengthening the material, and yet the nanofeatures are of a size comparable to the magnetic domain wall thickness of the matrix material so they may not significantly impede domain wall motion. Thus the matrix is strengthened by the nanofeatures without an accompanying decrease in soft magnetic properties, in contrast to what would be expected for conventional materials having coarser particle distributions, such as oxide-dispersion-strengthened (ODS) materials.

In one embodiment, the alloy matrix comprises titanium, at least about 35 weight percent iron, and up to about 60 weight percent cobalt. In one embodiment, the amount of iron present in the nanostructured ferritic alloy is at least about 50 weight percent, and in particular embodiments the amount of iron is at least about 75 weight percent, based on the weight of the nanostructured ferritic alloy. Cobalt, in some embodiments, is present in an amount from about 20 weight percent to about 55 weight percent. In some embodiments where high saturation magnetization is particularly desirable, the cobalt composition is in the range from about 20 weight percent to about 35 weight percent. In other embodiments, where low core loss is particularly desirable, the cobalt composition is in the range from about 45 weight percent to about 55 weight percent.

In some embodiments, the titanium is present in the range from about 0.1 weight percent to about 2 weight percent. In certain embodiments, the alloy matrix comprises from about 0.1 weight percent titanium to about 1 weight percent titanium. In addition to its presence in the matrix, titanium plays a role in the formation of the oxide nanofeatures, as described herein.

Vanadium is also present in the alloy matrix in certain embodiments, where it may serve to strengthen the alloy matrix. In some embodiments, the vanadium is present in a range from about 0.1 weight percent to about 2 weight percent, and in particular embodiments the range is from about 0.1 weight percent to about 1 weight percent.

Under certain conditions, an alloy that is richer in iron and that contains less cobalt than some of the embodiments described above is desirable, due in part, for example, to the comparatively high cost of cobalt relative to iron. Accordingly, in some embodiments the alloy matrix comprises titanium, at least about 40 weight percent iron, and up to about 8 weight percent silicon. In particular embodiments, the cobalt level is less than about 5 weight percent. The silicon level, in some embodiments, is in a range from about 1 weight percent to about 6 weight percent, and in particular embodiments is in the range from about 2 weight percent to about 5 weight percent. In some embodiments, the titanium level is within any of the titanium composition ranges described above for other alloys used in embodiments of the present invention.

In any of the embodiments described previously, other elements also may be included in the alloy matrix composition. Examples include, but are not limited to, chromium, nickel, molybdenum, tungsten, silicon, niobium, aluminum, and tantalum. These elements are typically selected to enhance corrosion resistance, mechanical properties, and/or other attributes of the nanostructured ferritic alloy.

Chromium may be present up to about 30 weight percent, up to about 20 weight percent in some embodiments, and up to about 10 weight percent in particular embodiments. Vanadium may be present in these alloys in any of the ranges described previously for vanadium. Molybdenum may be present up to about 5 weight percent, up to about 3 weight percent in some embodiments, and up to about 0.5 weight percent in particular embodiments. Tungsten may be present in any of the ranges described for molybdenum, though it should be appreciated that the presence and amounts of molybdenum and tungsten, and any of the elements described herein, are independent of each other. Silicon may be present in any of the alloys described herein, in any of the ranges previously described for this element. Niobium, in some embodiments, is present up to about 2 weight percent, up to about 1.5 weight percent in certain embodiments, and up to about 0.5 weight percent in particular embodiments. Aluminum independently may be present in any of the weight percent ranges described for niobium, as may tantalum as well. Nickel may be present up to about 10 weight percent in some embodiments, up to about 8 weight percent in certain embodiments, and up to about 5 weight percent in particular embodiments. Furthermore, the alloy matrix may comprise carbon and/or nitrogen. These elements may be present up to about 0.5 weight percent in some embodiments, up to about 0.25 weight percent in certain embodiments, and up to about 0.1 weight percent in particular embodiments.

Additional elements may be present in controlled amounts to benefit other desirable properties provided by this alloy. The amount of these additions is selected so as not to hinder the magnetic performance of the alloy. In addition, the alloy may also comprise usual impurities found in commercial grades of alloys intended for similar service or use. The levels of such impurities are controlled so as not to adversely affect the desired properties.

In certain embodiments, the nanostructured ferritic alloys of the present invention have a crystalline structure, and are substantially free of any amorphous character. Thus the alloys provide excellent molding and processing properties, and the crystalline structure provides the enhanced magnetic properties (for example, saturation magnetization) and the strength for very rigorous end use applications. In general, the alloy matrix is characterized by an A2 and/or B2 crystal structure. In most embodiments, at least about 95 percent of the detectable phases are characterized by these crystal phases (individually or in combination). In some embodiments, at least about 98 percent of the detectable phases are A2 and/or B2. Other phases, which sometimes constitute the remainder of the alloy structure include oxide phases and carbide phases. In embodiments wherein the amount of cobalt is greater than about 20 weight percent the alloy matrix may be characterized by a B2 phase.

Some non-limiting examples of compositions for the nanostructured ferritic alloys are provided in table 1 below.

| | Example 1 | | Example 2 | | Example 3 | | Example 4 | |
|---|---|---|---|---|---|---|---|---|
| | range | | range | | range | | range | |
| Element | Low | high | Low | High | Low | high | Low | high |
| Chromium | 0 | 30 | 0 | 10 | 0 | 10 | 0 | 10 |
| Cobalt | 0 | 60 | 20 | 35 | 45 | 55 | 0 | 5 |
| Titanium | 0.1 | 2 | 0.1 | 1 | 0.1 | 1 | 0.1 | 1 |
| Vanadium | 0 | 2 | 0 | 1 | 0 | 1 | 0 | 1 |
| Molybdenum | 0 | 5 | 0 | 0.5 | 0 | 0.5 | 0 | 0.5 |
| Tungsten | 0 | 5 | 0 | 0.5 | 0 | 0.5 | 0 | 0.5 |
| Silicon | 0 | 6 | 0 | 5 | 0 | 5 | 0 | 5 |
| Niobium | 0 | 2 | 0 | 0.5 | 0 | 0.5 | 0 | 0.5 |
| Aluminum | 0 | 2 | 0 | 0.5 | 0 | 0.5 | 0 | 0.5 |
| Nickel | 0 | 10 | 0 | 5 | 0 | 5 | 0 | 5 |
| Tantalum | 0 | 2 | 0 | 0.5 | 0 | 0.5 | 0 | 0.5 |
| Carbon | 0 | 0.5 | 0 | 0.25 | 0 | 0.25 | 0 | 0.25 |
| Nitrogen | 0 | 0.5 | 0 | 0.25 | 0 | 0.25 | 0 | 0.25 |
| Iron | balance | balance | balance | balance | balance | balance | balance | balance |

In various embodiments, a number of additional elements may be employed to obtain or enhance certain properties in the soft magnetic component. However, the presence of certain elements (or their presence at certain levels) can sometimes be detrimental to the overall properties of the nanostructured ferritic alloys. For example, the presence of copper or manganese may reduce the saturation magnetization of the alloy. Copper may also increase the magnetic coercivity of the alloy. The undesirable increase in coercivity may result in a power loss (energy loss) when these alloys are employed within an alternating current circuit, for example, when used as rotors, or armatures. In one embodiment, the nanostructured ferritic alloy is substantially free of copper. As used herein, the phrase “substantially free of copper” refers to the presence of less than about 50 parts per million of copper, based on the total amount of the alloy. In one embodiment, the nanostructured ferritic alloy is substantially free of manganese. As used herein, the phrase “substantially free of manganese” refers to the presence of less than about 1 weight percent of manganese, based on the total weight of the alloy.

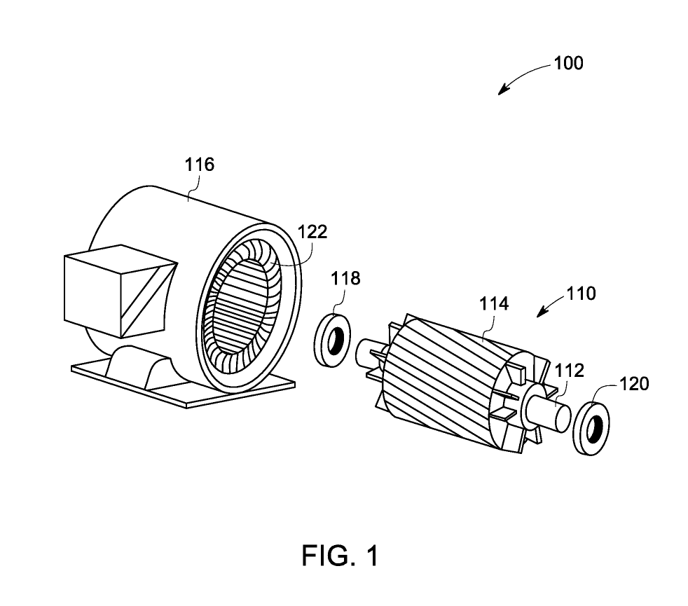

In one embodiment, the article described herein is an electrical machine. Referring to FIG. 1, a schematic three-dimensional view of an example of an electrical machine 100 is provided. FIG. 1 is provided for illustrative purposes only, and the present invention is not limited to any specific electrical machine or configuration thereof. In the illustrated example, the machine 100 includes a rotor assembly 110. The rotor assembly 110 includes a rotor shaft 112 extending through a rotor core 114. The rotor assembly 110 is capable of rotating inside the stator assembly 116 in a clockwise or a counter-clockwise direction. Bearing assemblies 118, 120 that surround the rotor shaft 112 may facilitate such rotation within the stator assembly 116. The stator assembly 116 includes a plurality of stator windings that extend circumferentially around and axially along the rotor shaft 112, through the stator assembly 116. During operation, rotation of the rotor assembly 110 causes a changing magnetic field to occur within the machine 100. This changing magnetic field induces voltage in the stator windings 122. Thus, the kinetic energy of the rotor assembly 110 is converted into electrical energy, in the form of electric current and voltage in the stator windings 122. Alternately, the machine 100 may be used as a motor, wherein the induced current in the rotor assembly 110 reacts with a rotating magnetic field to cause the rotor assembly 110 to rotate. In some embodiments, the motor is a synchronous motor, and in other embodiments, the motor is an asynchronous motor. Synchronous motors rotate at exactly the source frequency scaled up by the pole pair count, while asynchronous motors exhibit a slower frequency characterized by the presence of slip. One skilled in the art would know how to implement changes in the design, as per the requirement of the device.

One or more of the rotor assembly 110, or the stator assembly 116, of the machine 100 may include soft magnetic components of the disclosed embodiments. Superior magnetic and mechanical properties of the soft magnetic components of the disclosed embodiments provide distinct advantages in terms of the performance of the machine. In FIG. 1 described herein, the machine 100 is a radial type machine where the flux flows radially through the air gap between the rotor and the stator. However, other examples of the machine 100 may operate with axial flux flow as well, where the flux flows parallel to the axis of the machine 100. Though the operation of the machine 100 is explained with a simple diagram, examples of the machine 100 are not limited to this particular simple design.

Other more complicated designs are also applicable, and may benefit from the soft magnetic components described herein. In one embodiment, the soft magnetic component is a rotating component. Examples of the system that may comprise a rotating component include a generator, a motor, or an alternator. In one embodiment, the soft magnetic component is a rotor or an armature. In one embodiment, the soft magnetic component is a rotor of an electromagnetic machine.

In various embodiments, the alloys of the invention may exhibit high saturation magnetization, low coercivity, and high mechanical strength. In one embodiment, the soft magnetic component has a saturation magnetization of at least about 1.5 Tesla. In another embodiment, the soft magnetic component has a saturation magnetization of at least about 2 Tesla. In yet another embodiment, the soft magnetic component has a saturation magnetization of at least about 2.4 Tesla.

In one embodiment, the soft magnetic component has a coercivity of less than about 100 Oersteds. In another embodiment, the soft magnetic component has a coercivity of less than about 10 Oersteds. In yet another embodiment, the soft magnetic component has a coercivity of less than about 1 Oersted.

The high saturation magnetization values allow the soft magnetic component to be operated at very high flux densities, enabling compact electric machine designs. In one embodiment, the soft magnetic component disclosed herein has a yield strength of greater than about 850 mega Pascals. In another embodiment, the magnetic material has a yield strength of greater than about 1000 mega Pascals. In yet another embodiment, the magnetic material has a yield strength of greater than about 1200 mega Pascals.

An illustrative method for making the nanostructured ferritic alloy described previously comprises a first step of mechanically alloying metallic powder and a feedstock metal oxide to form a mechanically alloyed powder. The metallic powder generally comprises elements, as described above, that are desired to be present in the alloy matrix. The feedstock metal oxide, in some embodiments, comprises at least one oxide selected from yttria, hafnia, zirconia, and alumina. In some embodiments, mechanical alloying is accomplished by milling the powders together until the oxide is dissolved in the metallic powder.

A second step comprises consolidating the mechanically alloyed powder. The consolidation step may include, for example, hot isostatic pressing, extrusion, or rolling the powder into sheet via roll compaction. In one embodiment, after consolidating, the soft magnetic material has a density that is greater than about 95 percent of the theoretical density of the soft magnetic material. The step of consolidation may be carried out at elevated temperatures, and in such cases may also occur under an inert environment to minimize environmental interactions such as oxidation. Suitable examples of inert gas that may be employed to provide the inert environment include argon (Ar), nitrogen (N), and helium (He).

The powder is thermally treated to effect precipitation of the nanofeatures in the matrix. This formation of the nanofeature precipitates may be done at any time during the process of making the material, but is probably most convenient if performed during the consolidation step (if consolidation is performed at elevated temperatures) or after consolidation. In this step, titanium reacts with the oxygen and the metal species (e.g. yttrium, hafnium, zirconium, or aluminum) from the feedstock oxide to form oxides that make up the nanofeatures. Other elements from the metal may also participate in the reaction and become incorporated in the nanofeatures. The time and temperature selected for this precipitation can be readily designed based on the desired size and density of nanofeatures, and can be controlled to provide dispersions much finer than generally achieved by conventional means, such as purely mechanical alloying processes.

In embodiments employing roll compaction, following mechanical alloying, the powder may be fed into a rolling mill where the powder is compacted into sheets. The sheets of metal may then be sintered to create a dense body. In some embodiments, the sintered sheet may then be subjected to multiple rolling and sintering operations.

In some embodiments, a forming step follows hot isostatic pressing or extrusion, and this forming step may comprise forging the nanostructured ferritic alloy soft magnetic material to a plate and/or rolling the material to a sheet. In one embodiment, after the forming step the material has a density that is greater than about 98 percent of its theoretical density. In one embodiment, the method further comprises a step of machining the formed article.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An article comprising:
a soft magnetic component,
wherein the soft magnetic component comprises a nanostructured ferritic alloy, the nanostructured ferritic alloy comprising a plurality of nanofeatures disposed in an iron-containing alloy matrix, wherein the nanofeatures comprise an oxide.

2. The article of claim 1, wherein the soft magnetic component is a rotating component.

3. The article of claim 1, wherein the soft magnetic component is a rotor or an armature.

4. The article of claim 1, wherein the nanofeatures have an average size in a range of from about 1 nanometer to about 100 nanometers.

5. The article of claim 1, wherein the nanofeatures have an average size in a range of from about 1 nanometer to about 50 nanometers.

6. The article of claim 1, wherein the nanofeatures have an average size in a range of from about 1 nanometer to about 25 nanometers.

7. The article of claim 1, wherein the nanofeatures have a number density of at least about 10¹⁸ per cubic meter of the nanostructured ferritic alloy.

8. The article of claim 1, wherein the nanofeatures have a number density of at least about 10²⁰ per cubic meter of the nanostructured ferritic alloy.

9. The article of claim 1, wherein the nanofeatures have a number density of at least about 10²² per cubic meter of the nano structured ferritic alloy.

10. The article of claim 1, wherein the alloy matrix comprises:
titanium,
at least about 35 weight percent iron, and
up to about 60 weight percent cobalt.

11. The article of claim 10, wherein the alloy matrix further comprises at least one element selected from the group consisting of chromium, nickel, molybdenum, tungsten, silicon, niobium, aluminum, tantalum, and vanadium.

12. The article of claim 10, wherein the alloy matrix comprises from about 20 weight percent to about 55 weight percent cobalt.

13. The article of claim 10, wherein the alloy matrix comprises from about 20 weight percent to about 35 weight percent cobalt.

14. The article of claim 10, wherein the alloy matrix comprises from about 45 weight percent to about 55 weight percent cobalt.

15. The article of claim 10, wherein the alloy matrix comprises from about 0.1 weight percent to about 2 weight percent titanium.

16. The article of claim 10, wherein the alloy matrix comprises from about 0.1 weight percent to about 1 weight percent titanium.

17. The article of claim 10, wherein the alloy matrix further comprises vanadium.

18. The article of claim 17, wherein the alloy matrix further comprises from about 0.1 weight percent to about 2 weight percent vanadium.

19. The article of claim 17, wherein the alloy matrix comprises from about 0.1 weight percent to about 1 weight percent vanadium.

20. The article of claim 1, wherein the alloy matrix comprises
titanium,
up to about 8 weight percent silicon, and
at least about 40 weight percent iron.

21. The article of claim 20, wherein the alloy matrix comprises from about 1 weight percent to about 6 weight percent silicon.

22. The article of claim 20, wherein the alloy matrix comprises from about 2 weight percent to about 5 weight percent silicon.

23. The article of claim 20, wherein the alloy matrix comprises from about 0.1 weight percent to about 2 weight percent titanium.

24. The article of claim 20, wherein the alloy matrix comprises from about 0.1 weight percent to about 1 weight percent titanium.

25. The article of claim 20, wherein the alloy matrix further comprises at least one element selected from the group consisting of chromium, nickel, molybdenum, tungsten, niobium, aluminum, tantalum, cobalt, and vanadium.

26. The article of claim 1, wherein the oxide comprises
titanium, and
at least one element selected from the group consisting of yttrium, hafnium, aluminum, and zirconium.

27. The article of claim 26, wherein the oxide further comprises iron, chromium, nickel, molybdenum, tungsten, manganese, silicon, niobium, aluminum, tantalum, cobalt, or vanadium.

28. The article of claim 1, wherein the nanostructured ferritic alloy comprises:
an alloy matrix comprising
at least about 35 weight percent iron,
from about 0.1 weight percent to about 1 weight percent titanium, and
from about 20 weight percent to about 55 weight percent cobalt; and
a plurality of nanofeatures disposed in the alloy matrix, wherein the nanofeatures comprise an oxide, the oxide comprising titanium and at least one element selected from the group consisting of yttrium, hafnium, aluminum, and zirconium;
wherein the nanofeatures have an average size in a range of from about 1 nanometer to about 50 nanometers, and a number density of at least about 10²⁰ per cubic meter of the nanostructured ferritic alloy.

29. The article of claim 1, wherein the nanostructured ferritic alloy comprises:
an alloy matrix comprising
at least about 50 weight percent iron,
from about 0.1 weight percent to about 1 weight percent titanium, and
up to about 8 weight percent silicon; and
a plurality of nanofeatures disposed in the alloy matrix, wherein the nanofeatures comprise an oxide, the oxide comprising titanium and at least one element selected from the group consisting of yttrium, hafnium, aluminum, and zirconium;
wherein the nanofeatures have an average size in a range of from about 1 nanometer to about 50 nanometers, and a number density of at least about 10²⁰ per cubic meter of the nanostructured ferritic alloy.
